(19) United States
(12) Patent Application Publication
(10) Pub. No.: US 2024/0077374 A1
(43) Pub. Date: Mar. 7, 2024

(54) SINGLE-BAROMETER DEVICE, METHOD FOR FALL DETECTION, AND SYSTEM THEREOF

(71) Applicant: HONEYWLD TECHNOLOGY CORP., Hsinchu City (TW)

(72) Inventors: YI-PING CHENG, HSINCHU CITY (TW); SHENG-RON CHANG, HSINCHU CITY (TW); CHING-CHANG LIN, HSINCHU CITY (TW)

(21) Appl. No.: 17/901,943

(22) Filed: Sep. 2, 2022

(51) Int. Cl. G01L 9/00; G01C 5/06; G01P 15/18; G08B 21/04

(52) U.S. Cl. CPC G01L 9/0072; G01C 5/06; G01P 15/18; G08B 21/043

(57) ABSTRACT

A single-barometer device, a method for fall detection and a system are provided. The single-barometer device worn on a user is used to measure multiple barometric values continuously by a barometer inside the device. The barometric values are stored in a memory of the single-barometer device. When a current barometric value is produced, the current barometric value is compared with a previous barometric value retrieved from the memory. A barometric difference can be obtained. The barometric difference is then compared with a threshold, and a comparison result is used to determine whether or not a fall event is present. The fall event is confirmed if the barometric difference is larger than the threshold. Further, an acceleration change obtained by an accelerometer inside the single-barometer device can be used to reconfirm the fall event.

### FIELD OF THE DISCLOSURE

The present disclosure relates to a technology of fall detection; and more particularly to a method for fall detection through a single-barometer device and a system thereof.

### BACKGROUND OF THE DISCLOSURE

Long-term care is an important issue for an aging society. In addition to the need of caregivers, a long-term care system can use some technical methods to detect if a cared person is in danger. For example, it is dangerous for any cared person when he falls accidentally. Therefore, fall detection is an important issue for the long-term care.

There are many conventional methods for fall detection. One of the common ways is to let the cared person to wear a fall detection device. The fall detection device includes an accelerometer that is known as a gravity sensor (i.e., G-sensor). The accelerometer is able to measure acceleration values in several directions (e.g., X, Y, Z), and therefore can be used to determine the acceleration values that are generated as the cared person moves, e.g., a fall event.

More, if a drop occurs to the fall detection device worn on the cared person in a height instantaneously when the person falls. The drop can be measured by a barometer. However, it will be a great chance of misjudgment if only the barometer is used as a reference to process the fall detection. One of the reasons for the misjudgment is that great errors may happen since the atmospheric pressure varies greatly with different temperatures, locations and heights. Accordingly, the barometric value alone is not a reliable basis for detecting a fall event.

### SUMMARY OF THE DISCLOSURE

The present disclosure relates to a method for fall detection, a single-barometer device and a system. The method for fall detection is performed by a single-barometer device having a single barometer. The barometer is used to measure a series of barometric values continuously. These barometric values can be used to obtain continuous pressure changes in a user's environment and states. The barometric values are stored to a memory of the single-barometer device.

When the barometer measures a current barometric value, the current barometric value is compared with a previous barometric value obtained from the memory so as to obtain a barometric difference. The barometric difference is compared with a threshold so as to determine if any fall event is present.

Further, if the barometric difference is not larger than the threshold, the device continues the step for measuring barometric values. Otherwise, if the barometric difference is larger than the threshold, it is determined that a fall event is present and a warning message is generated.

Still further, in one embodiment, an accelerometer is incorporated for assisting in confirming the fall event for the single-barometer device. In an aspect, if the barometric difference is larger than the threshold, the accelerometer provides an acceleration change that is used to compare with a second threshold for confirming the determined fall event. If the acceleration change is larger than the second threshold, the fall event is confirmed and the warning message is then generated.

In another aspect, if the acceleration change is not larger than the second threshold, it shows that the user is in a still mode. In the meantime, the single-barometer device starts a timer to count time. When the still mode lasts to reach a time threshold, the warning message is generated.

In one further aspect, before determining the fall event by comparing the barometric difference with the first threshold, a series of continuous acceleration values generated by the accelerometer of the single-barometer device are firstly obtained for determining an acceleration change as the fall event is determined. If the acceleration change is larger than the second threshold, the barometric difference is compared with the first threshold. In the meantime, the fall event can be confirmed if the barometric difference is larger than the first threshold. The warning message is then generated.

In one aspect, the system for fall detection includes the single-barometer device that is worn on the user. A micro-controller of the single-barometer device performs the method for fall detection. The system further includes a software program executed in an electronic device. The electronic device connects with the single-barometer device via a wireless communication protocol, and acquires the continuous barometric values measured by the single barometer through the software program.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram depicting a system for fall detection using a single-barometer device according to one embodiment of the present disclosure;

FIG. 2 is a block diagram describing a single-barometer device according to one embodiment of present disclosure;

FIG. 3 is a flowchart describing a method for fall detection using a single-barometer device according to one embodiment of the present disclosure;

FIG. 4 is another flowchart describing the method for fall detection using a single-barometer device according to another embodiment of the present disclosure;

FIG. 5 is one further flowchart describing the method for fall detection that uses a single-barometer device having a single barometer that cooperates with an accelerometer according to one further embodiment of the present disclosure;

FIG. 6 is still one further flowchart describing the method for fall detection that uses the single-barometer device having the single barometer, the accelerometer and a timer according to one further embodiment of the present disclosure;

FIG. 7 shows experimental data of operation of the single-barometer device in one embodiment of the present disclosure; and

FIG. 8 is a timing diagram depicting barometric differences calculated for fall and faint detection through the single barometer.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The present disclosure relates to a method for fall detection, a single-barometer device and a system. In particular, only one barometer is used in the single-barometer device for performing the method for fall detection. That is, the standalone single-barometer device will not interact with any other barometer and needs not to synchronize data with each other. Even if the barometer will be greatly affected by temperature, altitude and environmental changes at every moment, no calibration is required for fall detection using the only one barometer. One of the major technical concepts is that the data that is used to detect a fall event is a relative change between a current and a previous barometric values detected by the single-barometer device within a very short period of time. Therefore, the value detected by the single-barometer device needs not to be calibrated or synchronized with the other device.

The single-barometer device is worn on a cared person. According to one embodiment of the method for fall detection performed in the single-barometer device, a barometer in the single-barometer device is used to measure a barometric value at a current location of the cared person. The barometric values measured by the barometer change with different heights of the location. In general, the effect of the environment on the air pressure does not change much within a limited period of time (e.g., within seconds), and therefore any uncertainty of the sensitive barometer due to the environment within the limited period of time can be ignored. Two or more barometric values measured within the limited period of time can be referred to for determining whether or not the body of the cared person suffers a large change, e.g., a fall event. The fall makes the single-barometer device worn on the cared person to generate a drastic height change, and the measured barometric value also changes. The degree of change of the barometric value acts as a major basis to determine the fall event.

The single-barometer device is worn on the cared person who is under a fall detection protection. One of the advantages of using the single-barometric device to perform fall detection is only to wear the single-barometric device on the cared person without any additional device. Further, a chip with good computing power is not required for the computing requirement is low. The method for fall detection is reliable since the change of the barometric values will not be affected by environmental changes such as changes of the temperature and the height when it is based on a relative change of barometric values.

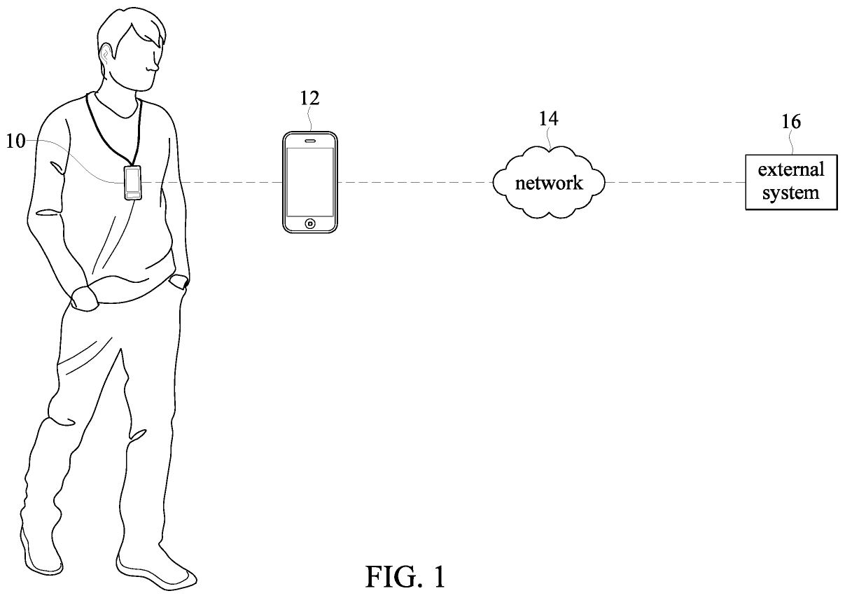

FIG. 1 is a schematic diagram depicting a system having a single-barometer device for fall detection according to one embodiment of the present disclosure.

The diagram shows a cared person who wears a single-barometer device 10. Besides the necklace type single-barometer device 10 shown in the diagram, the single-barometer device 10 can be a brooch type, a bracelet type, a specific type of device worn or fixed on a specific position of a user who can be the cared person. Thus, when the cared person falls or encounters a larger change in height, the single-barometer device 10 worn on the cared person can measure a barometric difference between a current barometric value and a previous barometric value due to a height drop. The barometric difference is generated instantaneously and becomes a major basis which is referred to for determining if any fall event is present. The method for fall detection is based on the instantaneous barometric difference and no synchronization or calibration with other device is required before the fall detection is performed even if the single-barometer device 10 has its own errors.

One of the main circuit components of the single-barometer device 10 is a barometer. The barometer is used to measure the barometric values of a user's location at different moments. If it requires to be carried conveniently, the single-barometer device can adopt an electronic barometer. One of the arrangements of the barometer is to form a capacitive diaphragm on a sensor, in which a capacitance of the capacitive diaphragm is changed when the diaphragm is under a pressure. The change of the capacitance of the diaphragm can be used to calculate the pressure. The single-barometer device 10 uses the barometer to continuously measure a series of barometric values. The barometric values are buffered in a memory of the single-barometer device 10. A processing circuit of the single-barometer device 10 is used to calculate changes of the barometric values. Alternatively, the single-barometer device 10 has a communication circuit that is used to communicate with an external device, e.g., an electronic device 12 shown in the diagram. The electronic device 12 can be a mobile device or a computer device. The external device can be used to record the barometric values measured by the barometer. The changes of the barometric values over time can be interpreted by a computing power of the electronic device 12.

The system for fall detection provides a software program executed in the electronic device 12. With a mobile device as an example, the software program can be a mobile application (e.g., APP) executed in the electronic device 12. The electronic device 12 connects with the single-barometer device 10 through a wireless communication protocol. The data can be transmitted under the wireless communication protocol. The software program can be used to obtain a series of barometric values that are measured by the single-barometer device 10.

A procedure of fall detection can be performed only by the single-barometer device 10. The procedure can also be performed by the electronic device 12 or any external system 16 that is connected with the single-barometer device 10 over a network 14. The electronic device 12 or the external system 16 relies on the data provided by the single-barometer device 10 at every end to confirm a fall event. In the work of caring, the single-barometer device 10 is used to determine whether or not the cared person encounters a dangerous change such as falling. If the fall event is determined, the external system 16 is notified. The external system 16 can be a care center, a medical institution, a security system or a specific person. The external system 16 performs subsequent measures for the fall event.

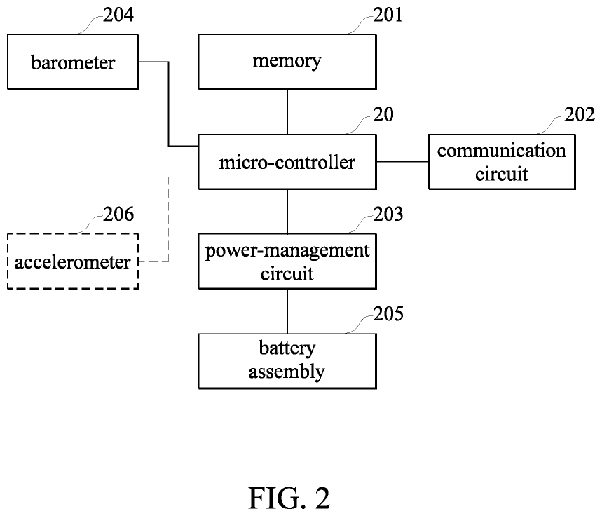

FIG. 2 is a block diagram illustrating circuit blocks of the single-barometer device according to one embodiment of the present disclosure.

The block diagram shows main circuit components of the single-barometer device. The single-barometer device can be a wearable pressure detection device that can be worn on a cared person. The main circuit components include a micro-controller 20 and other components electrically connected with the micro-controller 20. One of the circuit components is a memory 201 that can be a storage device of the single-barometer device. The memory 201 stores the barometric values measured by a barometer. A communication circuit 202 of the single-barometer device can be, but not limited to, implemented by WiFi™ or Bluetooth™ communication circuit that is used to communicate with the external system, a networking device or a personal mobile device. The single-barometer device includes a barometer 204 that is used to measure the barometric value of the location of the single-barometer device. The single-barometer device includes a power-management circuit 203 that is used to manage power supplied to the single-barometer device. The single-barometer device can be powered by a battery assembly 205 that especially requires a power management mechanism for long-term operation of the device.

According to one embodiment of the present disclosure, when the single-barometer device is in operation, the micro-controller 20 processes the barometric values generated by the barometer 204. After that, the barometric values are stored in the memory 201. The power-management circuit 203 controls the power being supplied for operating the device. When the single-barometer device does not transmit data, the communication circuit 202 can be shut down or enter a power-saving mode. The single-barometer device can be activated if a specific condition is met, for example, a result of fall detection is positive or the device is triggered by an external device. The power-management circuit 203 manages charging or discharging the battery assembly 205.

In one embodiment of the present disclosure, the single-barometer device includes an accelerometer 206, which is electrically connected with the micro-controller 20. The accelerometer 206 can be turned off or in a power-saving mode under a normal state. When a calculation program in the micro-controller 20 determines a fall event, the accelerometer 206 can be activated to generate sensing data of acceleration and obtain a direction, a displacement and an acceleration value that can assist in confirming the fall event. Therefore, the single-barometer device can get more accurate result of fall detection.

In one further embodiment of the present disclosure, the accelerometer 206 can be full-time operated for detecting actions of the single-barometer device. The acceleration data generated by the accelerometer 206 can be used to verify the barometric values and the barometric changes obtained from the barometer 204.

The communication circuit 202 is a circuit of the single-barometer device for connecting with an external device or system. When the single-barometer device connects with an external computer device, the barometric data can be transmitted to the computer device. The barometric values can be analyzed by a software program executed in the computer device. The computer device can display the barometric values. The computer device can upload the data to the other external system or transmit a warning message for fall detection to the external system such as a care center, a medical institution or a contact for performing follow-up actions.

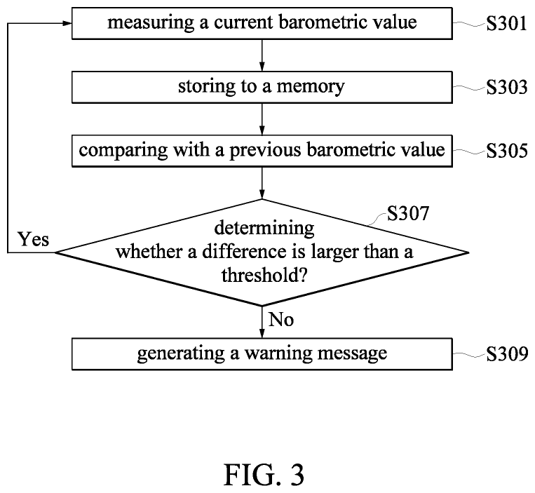

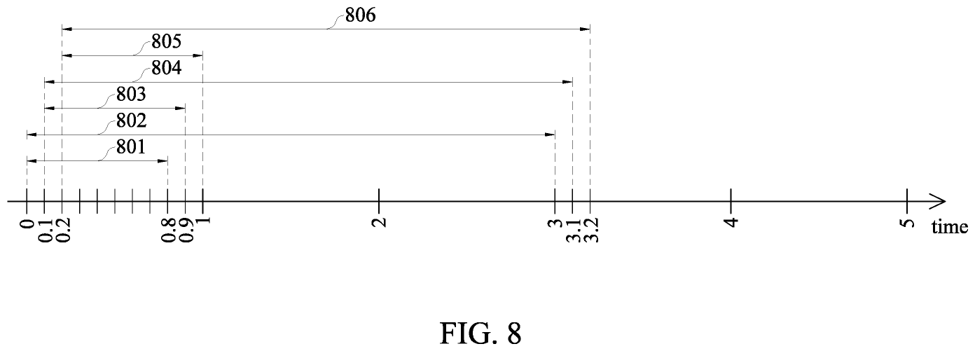

Reference is made to FIG. 3, which is a flowchart illustrating the method for fall detection with the single-barometer device according to one embodiment of the present disclosure. The flowchart illustrates a process using the single barometer to perform fall detection. In one of the embodiments of the present disclosure, the micro-controller of the single-barometer device primarily performs the method for fall detection. Reference is also made to FIG. 8 that depicts a schematic timing chart that is used to illustrate a procedure for continuously calculating barometric differences based on the barometric values measured by the single barometer.

It is understood that, from a beginning of cared person falling to a ground, this falling process will take a short time based on experiments and/or experiences. Accordingly, the duration of the falling process can be referred to in the method for fall detection so as to effectively determine a fall event according to the barometric differences. On the other hand, rather than the fall process, a faint process will take a longer time. Reference is made to FIG. 8, which is a schematic diagram illustrating a timing of continuous barometric values measured by the single barometer. In the single-barometer device, the barometric differences can be calculated continuously according to the barometric values measured before and after every time. In an aspect of the present disclosure, the above-mentioned duration of the falling process or the faint process can be referred to for the process of calculating the barometric differences. An exemplary example shows the duration is 0.8 seconds in the fall process, although it is not limited to a practical application. In the timing chart, the barometric values are continuously measured at a beginning time “0” and at a time “0.8” after a falling barometric difference calculation cycle 801. A barometric difference can be calculated between a barometric value at time “0” and a next barometric value after 0.8 seconds. In the method for fall detection, it is determined if any fall event is present according to the barometric difference within the very short time. Similarly, after a next falling barometric difference calculation cycle 803, a next barometric difference is calculated between the barometric values being measured at 0.1 second and at 0.9 second respectively. Further, after another falling barometric difference calculation cycle 805, another barometric difference is calculated between the barometric values being measured at 0.2 second and at 1.0 second respectively. Accordingly, the barometric differences can be continuously calculated at each of calculation cycles so as to effectively determine the fall event.

The method for fall detection is performed after the single-barometer device is activated. In the method for fall detection, the single barometer continuously measures the barometric values. A current barometric value can be obtained at every measurement (step S301). A procedure operated in the single-barometer device stores the barometric value being measured into a memory over time. The barometric values being continuously measured include a current barometric value, a previous barometric value that can be retrieved from the memory and more past barometric values (step S303). It is worth noting that, in the method for fall detection, the current barometric value and the previous barometric value are compared so as to determine the fall event. It should be noted that the current and previous barometric values are measured at an interval of the falling barometric difference calculation cycle. Furthermore, the past multiple barometric values stored in the memory can also be used to verify that the differences between every two barometric values can be used to reconfirm the fall event. It should be noted that the length of time to store the barometric values can be adjusted according to a size of the memory, setting by a user, setting by a designer of the device as demands. The method for fall detection is generally based on the barometric values stored in the memory for fall detection.

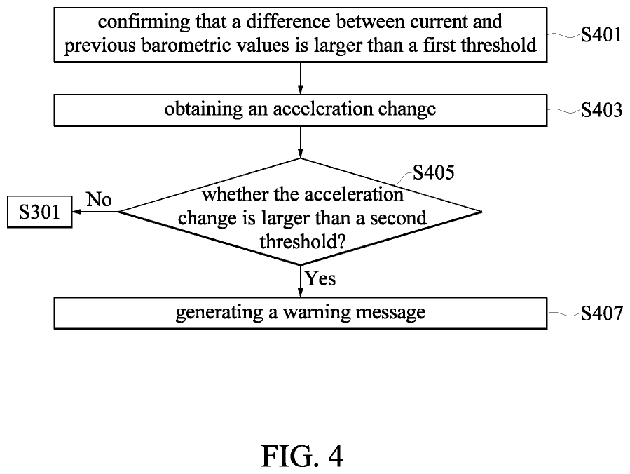

In the method for fall detection, when a current barometric value is obtained, one or more previous barometric values are also retrieved from the memory. In step S305, the current barometric value is compared with the previous barometric value so as to form a barometric difference. The barometric difference indicates a state of a cared person and can be used to determine if any larger change is present as compared to the previous state. In step S307, the barometric difference is compared with a system-preset threshold, i.e., a first threshold of FIG. 4, so as to determine if the barometric difference is larger than this threshold. A comparison result can be used to determine if any fall event is present. It should be noted that a general fall event does not occur instantly and therefore a time interval can be introduced when the barometric values are continuously obtained. For example, the time interval is set between the current barometric value and the previous barometric value when the two values are used to calculate the barometric difference. The follow-up embodiments introduce the falling barometric difference calculation cycle and the fainting barometric difference calculation cycle for effectively and accurately identifying the fall event and the faint event.

Moreover, the threshold can still be personalized and can be set by a caregiver, the cared person or service personnel when initializing the single-barometer device. The threshold can be set through software in a computer device that is connected with the single-barometer device. The threshold can be flexibly set by referring to a height of the cared person, a position of the single-barometer device worn on the cared person, or a location of the cared person. For example, if the cared person is taller, any change of his body often causes a larger change in height and the barometer can also measure a larger barometric difference in general. Therefore, the threshold can be adjusted higher for accurately determining the fall event since the taller one will cause a larger drop in height than a shorter one when he falls. On the contrary, if the single-barometer device is worn on a shorter person, the threshold can be adjusted lower for the single-barometer device to measure the barometric value more sensitive for avoiding any fall event that is with a small change in height from being ignored.

In the determination step S307, if the barometric difference between the current barometric value and the previous barometric value is not larger than the threshold, the process goes back to step SS301 for continuously measuring the barometric values. Otherwise, if the barometric difference is larger than the threshold, it indicates a fall event and the process goes on the step S309 for generating a warning message. For example, the warning can be issuing an alarm, notifying a specific contact or contacting an external system.

The warning message forms a notification for notifying a care center, a medical institution or a specific person.

In one further embodiment of the present disclosure, the determination in step S307 can be performed by an external system, in which the barometric values measured by the single-barometer device are configured to be uploaded to a specific system such as a private cloud, a local server or a cloud server. The steps such as calculating the barometric differences between every two barometric values, comparing with the threshold and determining whether or not to issue a warning message can be performed by software service in the external system.

Furthermore, in another aspect of the present disclosure, the single-barometer device can incorporate an accelerometer for assisting the fall detection.

In one further embodiment of the present disclosure, the threshold used for fall detection can be decided through an equation. The equation for deciding the threshold can be configured in a software process running in the single-barometer device. The software process allows a user to input a height of a cared person, a position of the device worn on the cared person, the type or model of the device, and a location of the cared person and the threshold can be automatically made through the equation. The arithmetic values and units are decided according to an actual implementation.

In another embodiment of the present disclosure, the threshold can be set up by a software process operated in the single-barometer device. The software process can be capable of learning for adjusting the threshold if the single-barometer device fails to detect the fall event when the cared person falls, a warning message is issued but the cared person does not fall, or a user provides calibration information.

According to one more embodiment of the present disclosure, reference is made to FIG. 4, which is a flowchart illustrating the method for fall detection through a single barometer and an accelerometer of the single-barometer device.

Another sensor is incorporated to the single-barometer device in this aspect for confirming a fall event that is determined by the device. In addition to the single barometer of the single-barometer device, an accelerometer is involved to continuously sense moving directions, displacements and acceleration values of the single-barometer device. In one of the embodiments of the present disclosure, the single-barometer device continuously measure barometric values by the single barometer, in the meantime, the accelerometer also continuously generates acceleration values and calculates acceleration changes. Both the single barometer and the accelerometer are used to confirm the fall event through mutual assistance. The single-barometer device can therefore effectively reduce an error rate for alarming and solve the problem that no warning issues but the fall event occurs.

In FIG. 4, such as in step S401, it is confirmed that the barometric difference is larger than the threshold through the process of FIG. 3. The threshold is a first threshold. Since the fall event is confirmed, such as in step S403, the single-barometer device further acquires an acceleration change between a current acceleration value and a previous acceleration value from the accelerometer. It is worth noting that the time interval between the current and the previous acceleration values can be the time interval used for measuring the barometric values in the above process.

Next, such as in step S405, the acceleration change is compared with another threshold, i.e., a second threshold. When the fall event is determined, it is also determined whether or not the acceleration change is larger than the second threshold. The fall event can be reconfirmed through the acceleration change.

If the acceleration change is not larger than the second threshold, the flow can be terminated, and goes back to step S301 of FIG. 3. Otherwise, if the acceleration change is larger than the second threshold, the fall event is confirmed. After that, such as in step S407, a warning message is issued. For example, the warning message forms a notification being transmitted to an external system or specific personnel.

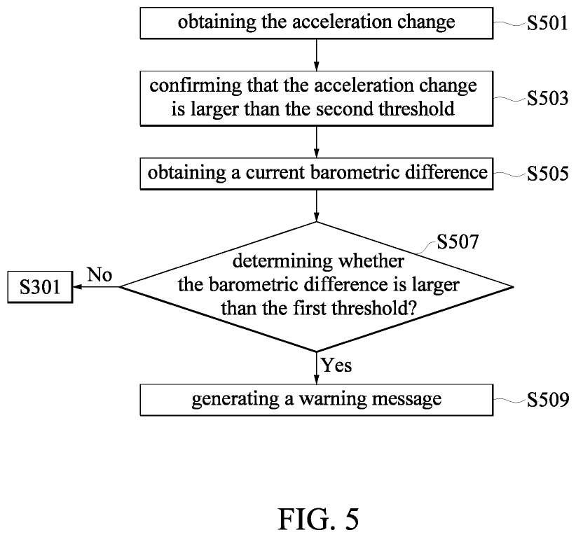

FIG. 5 is a flowchart illustrating the method for fall detection that utilizes a single barometer and an accelerometer in the single-barometer device according to a second embodiment of the present disclosure.

Rather than the flowchart illustrated in FIG. 4, according to the present embodiment, before determining whether or not any fall event is present by comparing the barometric difference with the first threshold, such as in step S501, the acceleration value generated by the accelerometer is firstly obtained in the beginning. An acceleration change between a current acceleration value and a previous acceleration value is calculated. In step S503, a collision event is determined if it is confirmed that the acceleration change is larger than the second threshold. In the current aspect, such as in step S505, a current barometric difference is obtained under this collision event. In step S507, it is determined whether or not the barometric difference is larger than the first threshold.

If the barometric difference is not larger than the first threshold, it indicates that a height drop of the barometer does not meet a predetermined threshold and the process goes back to step S301 of FIG. 3 for continuing the process of fall detection since it is unable to regard the collision event as a fall event. Otherwise, if the acceleration change is larger than the second threshold, and also the barometric difference is larger than the first threshold, such as in step S509, a fall event is confirmed and a warning message is generated.

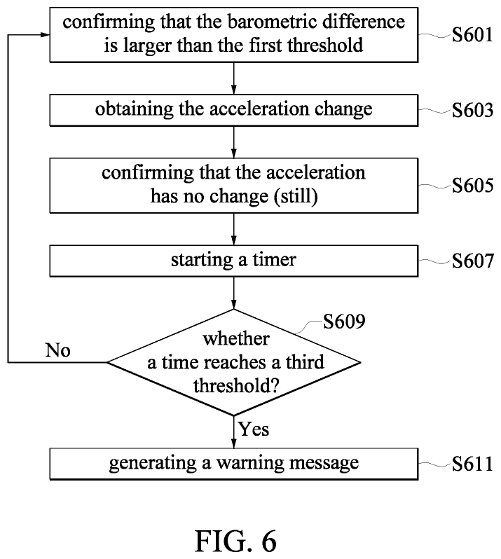

FIG. 6 is another flowchart illustrating the method for fall detection through a single-barometer device that includes cooperative a single barometer, an accelerometer and a timer according to another embodiment of the present disclosure. Reference is also made to FIG. 8, which shows a timing chart depicting the barometric differences being calculated by the single-barometer device for a faint event.

In the current example, a faint cared person may not have a violent collision even if he is in a state of falling. Nonetheless, the cared person is already in a faint state. The single-barometer device can still detect the faint state through the process. In the beginning, such as in step S601, the barometer produces a series of barometric values and also provides the barometric differences continuously. Based on a common knowledge and experience, the faint event can be a relatively slow falling process.

Reference is made to FIG. 8, which shows that the barometric differences can be calculated from the continuously-obtained barometric values generated by the single-barometer device based on a longer calculation cycle. As shown in the diagram, the barometric values are continuously obtained from time “0-second.” The calculation cycle in the current example is, but not limited to, 3 seconds. After a fainting barometric difference calculation cycle 802, a barometric difference from time “0-second” to time “3-second” is calculated at third second. After a next fainting barometric difference calculation cycle 804, a next barometric difference from time “0.1-second” to time “3.1-second” is calculated. After one more fainting barometric difference calculation cycle 806, one more barometric difference from time “0.2-second” to time “3.2-second” is calculated. The barometric differences can be continuously calculated based on the calculation cycle so as to effectively determine the faint event.

In step S601 of FIG. 6, it is confirmed that the barometric differences calculated based on the fainting barometric difference calculation cycles (e.g., 802, 804 and 806) that are larger than the first threshold are consistent with a faint phenomenon, and the process goes on step S603, an accelerometer is used to continuously generate acceleration values and obtain an acceleration change. In step S605, the acceleration change is then compared with a second threshold so as to confirm that the acceleration is not changed. Since the acceleration change is “0”, it is determined that the cared person wearing the single-barometer device is in a static mode. For example, if the cared person lies on a ground, the acceleration change will be “0” and the cared person can be regarded as in a faint state but not a fall event.

In the meantime, such as in step S607, the single-barometer device starts a timer to count time and measures duration of the static mode. In step S609, it is determined if the duration reaches a third threshold that is regarded as a time threshold. The cared person is determined to be in moving but not in faint state if the duration of the static mode does not reach the time threshold. The process goes back to step S601.

However, if the duration of static mode reaches the time threshold, the cared person is determined to be in faint state, such as in step S611, a warning message is generated. It should be noted that, in the present embodiment, if a barometric difference obtained from the barometric values that are continuously generated by the barometer indicates the cared person encounters a height drop that can be regarded as a fall event, but the acceleration change does not reaches the threshold, the cared person is determined to be in a state of slow falling and in the static mode. For the purpose of caring, the single-barometer device or the system can determine if the cared person is in a faint state according to the duration of the static mode.

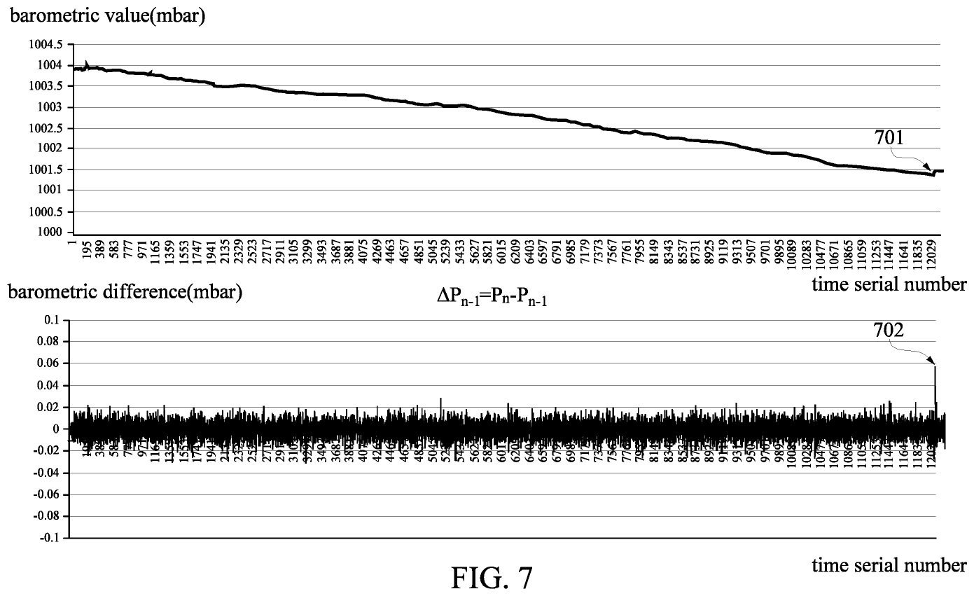

FIG. 7 shows experimental data that is produced when the single-barometer device is in operation. The experimental data is the actual data that is measured by a single barometer in the single-barometer device. The experimental data can be used to show that the single barometer can achieve the proposed technical effect.

According to the actual data measured by the single barometer shown in FIG. 7, the vertical axis of the above chart denotes a barometric value (mBar) and the horizontal axis thereof denotes a time serial number over time; the vertical axis of the below chart denotes the barometric difference (ΔP=Pₙ−Pₙ₋₁) between a current barometric value (Pₙ) and a previous barometric value (Pₙ₋₁) and the horizontal axis also denotes the time serial number over time. The charts show the results of continuously measured data, stored data and the barometric differences produced by the single barometer.

The data in the above chart indicates that the continuously-measured and stored barometric values appear a continuous downward trend. It should be noted that a traditional single barometer cannot determine any fall event from the downward trend without a reference or calibration. However, according to the experimental data, there is an obvious change (e.g., suddenly falling on the ground) at time serial number “12029” of the above chart and it is marked as a “fall event barometric change 701.” In the meantime, an obvious change, i.e., a “fall event barometric difference 702” is also obtained at the same time serial number “12029” of the below chart that shows the barometric differences that are continuously calculated from every instant barometric value and the previous barometric value. After compared with the first threshold, a comparison result allows the single-barometer device to determine if any fall event is present.

In conclusion, according to the embodiments of the method for fall detection, the single-barometer device and the system of the present disclosure, the single-barometer device is particularly a fall detection device worn on a cared person for measuring barometric values at a location of the cared person. The fall detection device can periodically and continuously measure the barometric values at the location. It is characterized in that the fall detection device is a single-barometer device having a single barometer. Especially, no initialization such as calibration and clock synchronization for the single-barometer device is required, and it is not necessary to cooperate with other device for the device can perform the method for fall detection independently. Further, if the fall detection device is connected with the other device, it is convenient for only recording data and communicating with other systems.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for fall detection, comprising:
using a barometer of a single-barometer device worn on a user to continuously measure a plurality of barometric values, and storing the barometric values into a memory of the single-barometer device;
using the barometer to measure a current barometric value and to compare with a previous barometric value so as to obtain a barometric difference, wherein the previous barometric value is retrieved from the memory; and
comparing the barometric difference with a first threshold, and determining if any fall event is present according to a comparison result.

2. The method according to claim 1, wherein, when the barometric difference is not larger than the first threshold, the step of measuring the barometric values is repeated; when the barometric difference is larger than the first threshold, a warning message is generated.

3. The method according to claim 2, wherein, when the barometric difference is larger than the first threshold, a series of continuous acceleration values generated by an accelerometer are obtained simultaneously for determining an acceleration change of the fall event and the acceleration change is compared with a second threshold so as to confirm the fall event.

4. The method according to claim 3, wherein, when the acceleration change is larger than the second threshold, the fall event is confirmed and the warning message is generated; alternatively, when the acceleration change is not larger than the second threshold, the user enters a static mode and the single-barometer device starts a timer; and a warning message is generated if the static mode lasts to reach a time threshold.

5. The method according to claim 1, wherein, before determining if the fall event is present by comparing the barometric difference with the first threshold, a series of continuous acceleration values generated by an accelerometer of the single-barometer device are obtained so as to acquire a current acceleration change when the fall event is determined.

6. The method according to claim 5, wherein, when the acceleration change is larger than a second threshold, the barometric difference is again compared with the first threshold, the fall event is confirmed if the barometric difference is larger than the first threshold, and the warning message is generated.

7. The method according to claim 1, wherein the first threshold is set according to one or any combination of a height of the cared person, a position to wear the single-barometer device, and the user's location.

8. The method according to claim 1, wherein the barometric difference is obtained by comparing the current barometric value with the previous barometric value at an interval of a falling barometric difference calculation cycle or a fainting barometric difference calculation cycle.

9. A system for fall detection, comprising:
a single-barometer device worn on a user, wherein the single-barometer device includes a micro-controller, a memory and a barometer, and the barometer measures barometric values in the user's location at different times, and the barometric values are stored in the memory;
wherein the micro-controller performs a method for fall detection for:
using the barometer to measure a current barometric value;
comparing the current barometric value with a previous barometric value so as to obtain a barometric difference; and
comparing the barometric difference with a first threshold, and determining if any fall event is present according to a comparison result.

10. The system according to claim 9, wherein, when the barometric difference is not larger than the first threshold, the step of measuring the barometric values is repeated; when the barometric difference is larger than the first threshold, a warning message is generated.

11. The system according to claim 10, wherein, when the barometric difference is larger than the first threshold, a series of continuous acceleration values generated by an accelerometer are obtained at the same time so as to determine a current acceleration change when the fall event is determined;
wherein the acceleration change is compared with a second threshold for confirming the fall event.

12. The system according to claim 11, wherein, when the acceleration change is larger than the second threshold, the fall event is confirmed and the warning message is generated; alternatively, when the acceleration change is not larger than the second threshold, the user enters a static mode and the single-barometer device starts a timer; and a warning message is generated if the static mode lasts to reach a time threshold.

13. The system according to claim 9, wherein, before determining if the fall event is present by comparing the barometric difference with the first threshold, a series of continuous acceleration values generated by an accelerometer of the single-barometer device are obtained so as to acquire a current acceleration change when the fall event is determined; wherein, when the acceleration change is larger than a second threshold, the barometric difference is again compared with the first threshold, the fall event is confirmed if the barometric difference is larger than the first threshold, and the warning message is generated.

14. The system according to claim 9, wherein the barometric difference is obtained by comparing the current barometric value with the previous barometric value at an interval of a falling barometric difference calculation cycle or a fainting barometric difference calculation cycle.

15. A single-barometer device, being worn on a user, wherein the single-barometer device comprises:
a micro-controller;
a memory, electrically connected with the micro-controller;
a barometer, electrically connected with the micro-controller;
wherein, the barometer is used to measure different barometric values at different times in a location of the user, and the barometric values are stored in the memory;
wherein the micro-controller performs a method for fall detection comprising:
using the barometer to measure a current barometric value;
comparing the current barometric value with a previous barometric value measured by the barometer so as to obtain a barometric difference; and
comparing the barometric difference with a first threshold, and determining if any fall event is present according to a comparison result.

16. The single-barometer device according to claim 15, wherein, in the method for fall detection, when the barometric difference is not larger than the first threshold, the step of measuring the barometric values is repeated; when the barometric difference is larger than the first threshold, a warning message is generated.

17. The single-barometer device according to claim 16, wherein the single-barometer device includes an accelerometer, when the barometric difference is larger than the first threshold, a series of continuous acceleration values generated by the accelerometer so as to acquire a current acceleration change if the fall event is determined, and the fall event is confirmed by comparing the acceleration change with a second threshold.

18. The single-barometer device according to claim 17, wherein, when the acceleration change is larger than the second threshold, the fall event is confirmed and the warning message is generated; alternatively, when the acceleration change is not larger than the second threshold, the user enters a static mode and the single-barometer device starts a timer; and a warning message is generated if the static mode lasts to reach a time threshold.

19. The single-barometer device according to claim 15, wherein, before determining if the fall event is present by comparing the barometric difference with the first threshold, a series of continuous acceleration values generated by an accelerometer of the single-barometer device are obtained so as to acquire a current acceleration change when the fall event is determined; wherein, when the acceleration change is larger than a second threshold, the barometric difference is again compared with the first threshold, the fall event is confirmed if the barometric difference is larger than the first threshold, and the warning message is generated.

20. The single-barometer device according to claim 15, wherein the barometric difference is obtained by comparing the current barometric value with the previous barometric value at an interval of a falling barometric difference calculation cycle or a fainting barometric difference calculation cycle.
